(19) United States
(12) Patent Application Publication
(10) Pub. No.: US 2026/0125072 A1
(43) Pub. Date: May 7, 2026

(54) NOTIFICATION SYSTEM

(71) Applicant: DENSO CORPORATION, Kariya-city (JP)

(72) Inventors: Hiroki FURUKAWA, Kariya-city (JP); Mitsuharu HIGASHITANI, Kariya-city (JP); Noriaki IKEMOTO, Kariya-city (JP)

(73) Assignee: DENSO CORPORATION, Kariya-city (JP)

(21) Appl. No.: 19/376,237

(22) Filed: Oct. 31, 2025

(30) Foreign Application Priority Data
Nov. 6, 2024 (JP) 2024-194468

(51) Int. Cl. B60W 50/14; B60L 50/15; B60L 58/13; B60W 30/14; B60W 50/00

(52) U.S. Cl. CPC B60W 50/14; B60L 50/15; B60L 58/13; B60W 30/143; B60W 50/0098; B60L 2240/12; B60L 2240/34; B60L 2250/10; B60L 2250/16; B60W 2050/143; B60W 2050/146; B60W 2510/244; B60W 2520/10

(57) ABSTRACT

In a notification system, a determination unit determines whether a predetermined change related to a travel plan of a vehicle needs to be executed. A speed of the vehicle or a temperature of a predetermined portion of the vehicle is automatically controlled to approach a target value. The predetermined change is a first automatic change of the target value by an absolute difference, the absolute difference being not less than a predetermined threshold, or a second automatic change of the travel plan during traveling of the vehicle. A notification unit provides, prior to execution of the predetermined change, a notification to an occupant in response to determination that the predetermined change related to the travel plan needs to be executed. The notification includes a reason that the predetermined change related to the travel plan is to be executed and information on the predetermined change related to the travel plan.

### CROSS-REFERENCE TO RELATED APPLICATION

This present application is based on and claims the benefit of priority from Japanese Patent Application No. 2024-194468 filed on Nov. 6, 2024, the disclosure of which is incorporated herein by reference.

### TECHNICAL FIELD

The present disclosure relates to notification systems for vehicles.

### BACKGROUND

Japanese Patent Publication No. 3814050 discloses an emergency automatic braking apparatus for a vehicle that automatically actuates brakes in an emergency. In this apparatus, when an emergency occurs, the occurrence of an emergency is first notified, and thereafter the brakes are automatically actuated.

### SUMMARY

In recent years, technologies have been seen in which the speed of a vehicle for example is automatically controlled for purposes such as energy saving and comfortable driving. Such automatic vehicle-speed control, which is not intended by one or more occupants, may be performed. This may give the one or more occupants a sense of discomfort and, consequently, may impair the occupant's comfort.

The technology disclosed in the patent publication provides a notification function for the purpose of occupant safety and reassurance. Unfortunately, the technology does not consider a reduction of an occupant's discomfort when the automatic vehicle-speed control unintended by the occupant is performed. After detailed consideration by the inventors, the inventors have identified the above issues.

In view of the above issues, the present disclosure seems to provide a notification system capable of reducing an occupant's discomfort when, in automatic control of a vehicle, control unintended by one or more occupants is performed.

An exemplary aspect of the present disclosure provides a notification system for a vehicle. The notification system includes a determination unit configured to determine whether a predetermined change related to a predetermined travel plan of the vehicle needs to be executed. The vehicle is controlled to travel in accordance with the travel plan such that at least one of a speed of the vehicle or a temperature of a predetermined portion of the vehicle is automatically controlled to approach a target value. The predetermined change related to the travel plan is at least one of a first automatic change of the target value by an absolute difference in accordance with the travel plan, the absolute difference being not less than a predetermined threshold, and a second automatic change of the travel plan during traveling of the vehicle.

The notification system includes a notification unit configured to provide, prior to execution of the predetermined change, a notification to an occupant of the vehicle in response to determination that the predetermined change related to the travel plan needs to be executed. The notification includes (i) at least one reason that the predetermined change related to the travel plan is to be executed and (ii) information on the predetermined change related to the travel plan.

The above configuration of the notification system enables the occupant to recognize, prior to execution of the predetermined change related to the travel plan, that (i) the predetermined change related to the travel plan is to be executed and (ii) the at least one reason of the execution of the predetermined change related to the travel plan in accordance with the notification performed by the notification unit.

This therefore makes it possible to reduce, even if the execution of the predetermined change related to the travel plan is not intended by the occupant, an occupant's discomfort due to the occurrence of the predetermined change related to the travel plan.

Where reference characters are used in parentheses for various elements throughout the present disclosure, such characters are provided merely as an example of the correspondence between the elements and the specific structures in the embodiments described later. The present disclosure is therefore not limited by the use of such reference characters.

### BRIEF DESCRIPTION OF THE DRAWINGS

Other aspects of the present disclosure will become apparent from the following description of embodiments with reference to the accompanying drawings in which:

FIG. 1 is a side view schematically illustrating a vehicle to which a notification system according to the first embodiment of the present disclosure is to be applied;

FIG. 2 is a block diagram schematically illustrating typical components installed in the vehicle illustrated in FIG. 1 and typical components of a cloud that is communicably connected to the vehicle;

FIG. 3 is a timing chart illustrating a combination of graphs, each of which schematically shows an example of a transition of a corresponding one of a target vehicle speed, a target battery temperature, a target cabin temperature, and a predicted charge rate of a high-voltage battery;

FIG. 4 is a flowchart schematically illustrating a control routine for preparing a travel plan of the vehicle, which includes a scheduled travel route of the vehicle according to the first embodiment;

FIG. 5 is a schematic view two-dimensionally illustrating the scheduled travel route, roads, charging facilities at which the vehicle can be charged, and a current position of the vehicle;

FIG. 6 is a flowchart schematically illustrating a notification control routine to be executed by the notification system according to the first embodiment;

FIG. 7 is a functional block diagram schematically illustrating functional components included in the notification system according to the first embodiment; and

FIG. 8 is a flowchart schematically illustrating a notification control routine to be executed by a notification system according to second embodiment of the present disclosure, which corresponds to the notification control routine illustrated in FIG. 6.

### DETAILED DESCRIPTION OF EMBODIMENTS

The following describes exemplary embodiments of the present disclosure with reference to accompanying drawings. In the following exemplary embodiments, substantially identical or equivalent components are represented by the same reference characters and redundant explanations are omitted.

### First Embodiment

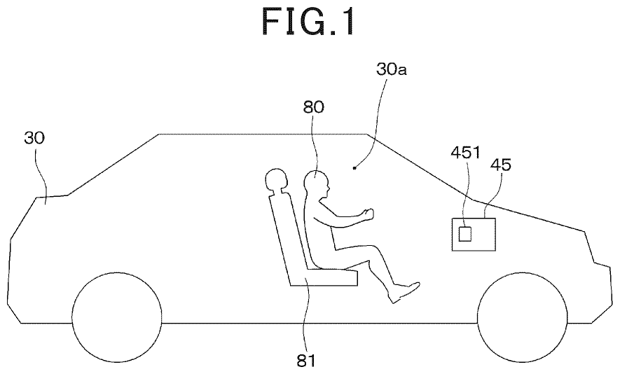

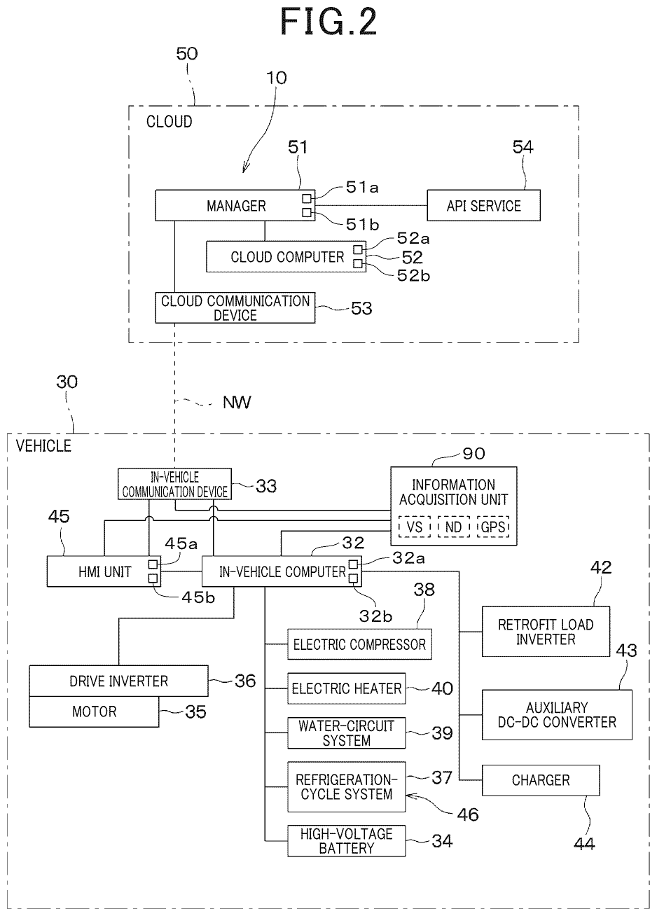

Referring to FIGS. 1 and 2, a notification system 10 according to the first embodiment is a vehicular notification system applicable to, for example, a vehicle, such as an electric vehicle, 30. The electric vehicle as the vehicle 30 according to the first embodiment will also be referred to as a Battery Electric vehicle (BEV), and the vehicle (BEV) 30 does not include an engine, and includes a high-voltage battery, i.e., a secondary battery, 34, and can travel based on power obtained from the high-voltage battery 34.

For example, the notification system 10 of the first embodiment is configured to perform a predetermined notification to the cabin 30a of the vehicle 30 for a purpose of reducing an occupant's discomfort. That is, the notification system 10 is configured to perform a predetermined notification to an occupant 80, such as a driver of the vehicle 30.

The notification system 10 includes, as a hardware configuration, an in-vehicle computer 32, an in-vehicle communication device 33, a manager 51, a cloud computer 52, and a cloud communication device 53. The in-vehicle computer 32 and the in-vehicle communication device 33, which are provided in the vehicle 30, are connected so as to be capable of communicating information with each other. The manager 51, the cloud computer 52, and the cloud communication device 53, which are provided in a cloud, i.e., a cloud server, 50, are connected so as to be capable of communicating information with each other; the cloud 50 is installed on the outside of the vehicle 30.

The cloud, i.e., cloud server, 50 refers to, for example, an external information processing environment that is communicably connected to the vehicle 30 via the wireless network NW. The cloud 50 may be implemented as a physical server, a group of servers, a virtualized environment, or any combination thereof, provided that the functions described herein are realized.

The in-vehicle communication device 33 is configured to cause plural components connected thereto via wired or wireless connection to communicate information with one another. Similarly, the cloud communication device 53 is configured to cause plural components connected thereto via wired or wireless connection to communicate information with one another.

Specifically, the in-vehicle communication device 33 of the vehicle 30 and the cloud communication device 53 of the cloud 50 are wirelessly connected to each other. This enables each component of the vehicle 30 and the manager 51 of the cloud 50 to communicate information with one another via a wireless network NW. The wireless network NW includes, for example, a wireless communication line of 4G or 5G and the Internet.

The in-vehicle computer 32, the manager 51, and the cloud computer 52 each have a configuration as a microcomputer provided with a CPU 32a, 51a, 52a and a storage 32b, 51b, 52b including, for example, a RAM, a ROM, and a non-volatile rewritable memory. Each of the in-vehicle computer 32, the manager 51, and the cloud computer 52 reads and executes computer programs, i.e., computer-program instructions, stored in the corresponding ROM or the non-volatile rewritable memory. Each of the ROM and the non-volatile rewritable memory serves as a non-transitory tangible storage medium. Executing the computer programs enables methods corresponding to the computer programs to be carried out.

That is, each of the in-vehicle computer 32, the manager 51, and the cloud computer 52 executes various control processes in accordance with the corresponding computer programs.

Each of the in-vehicle computer 32, the manager 51, and the cloud computer 52 is capable of executing control processing independently. Additionally, because the in-vehicle computer 32, the manager 51, and the cloud computer 52 are capable of information communication with one another, the in-vehicle computer 32, the manager 51, and the cloud computer 52 are capable of cooperating with each other to execute one control process as if they were a single computer.

As illustrated in FIG. 2, the vehicle 30 according to the first embodiment includes, in addition to the in-vehicle computer 32 and the communication device 33 described above, the high-voltage battery 34, a motor 35, a drive inverter 36, a refrigeration-cycle system 37, an electric compressor 38, a water-circuit system 39, and an electric heater 40. Additionally, the vehicle 30 includes a retrofit load inverter 42, an auxiliary DC (direct current)-DC converter 43, a charger 44, and an HMI (Human Machine Interface) 45.

The high-voltage battery 34 is a rechargeable secondary battery, and is constituted by, for example, a lithium ion battery or a nickel-hydrogen battery or a nickel-metal-hydride battery. The high-voltage battery 34 serves as a vehicle power supply that supplies current to each of the electric devices, which include the drive inverter 36, installed in the vehicle 30.

The motor 35 is a traction motor that rotationally drives drive wheels of the vehicle 30. Specifically, the motor 35 is configured to receive electric power supplied from the drive inverter 36 to accordingly rotate the driving wheels of the vehicle 30, thus propelling the vehicle 30. The drive inverter 36 is configured to convert a direct current from the high-voltage battery 34 into an alternating current, and supply the converted alternating current to the motor 35, thus rotating the motor 35.

The refrigeration cycle system 37 includes, for example, a plurality of heat exchangers, an expansion valve, a flow path switching valve. The refrigeration cycle system 37 and the electric compressor 38 constitute a refrigeration cycle circuit in which a refrigerant is circulated. In the refrigeration cycle circuit, circulation of the refrigerant enables a vapor compression refrigeration cycle to be executed. Execution of the refrigeration cycle enables temperature adjustment of the high-voltage battery 34, the motor 35, and the drive inverter 36, and air conditioning in the cabin 30a to be carried out.

The electric compressor 38 is configured to operate based on power supplied from the high-voltage battery 34 to draw in the refrigerant in the refrigeration cycle circuit, compress the refrigerant, and then discharge the compressed refrigerant. That is, the refrigerant is circulated in the refrigeration cycle circuit based on operation of the electric compressor 38, and the circulation of the refrigerant enables heat to be transferred from one of the plurality of heat exchangers to another based on the circulation of the refrigerant.

The water circuit system 39 includes a pump and one or more heat exchangers that constitute a water circuit in which a liquid medium such as cooling water is circulated. For example, at least one of the heat exchangers provided across both the water circuit and the refrigeration cycle circuit causes liquid medium in the water circuit to exchange heat with the refrigerant in the refrigeration cycle circuit. That is, the water circuit cooperates with the refrigeration cycle circuit to perform both (i) temperature adjustment of each of the thermal-management target devices connected to the water circuit, such as the high-voltage battery 34, the motor 35, and the drive inverter 36 and (ii) air conditioning in the vehicle cabin 30a.

The electric heater 40 is disposed, for example, in a cabin air-conditioning unit, and is configured to generate heat based on power supplied from the high-voltage battery 34. Specifically, the electric heater 40 is configured to heat air, which is to be blown out from the cabin air-conditioning unit to the cabin 30a, within the cabin air-conditioning unit.

As described above, the refrigeration cycle system 37, the electric compressor 38, the water circuit system 39, and the electric heater 40 as a whole perform air conditioning in the cabin 30a, temperature adjustment of the high-voltage battery 34, and temperature adjustment of the motor 35 and the power inverter 36. Accordingly, the refrigeration cycle system 37, the electric compressor 38, the water circuit system 39, and the electric heater 40 constitute a temperature control apparatus 46 that performs various temperature adjustments in the vehicle 30.

The retrofit load inverter 42 is an inverter for supplying power to one or more electrical loads retrofittable to the vehicle 30, that is, retrofit electrical loads. The retrofit load inverter 42 is configured to convert a voltage, i.e., a high voltage, across the high-voltage battery 34 into a voltage suitable for the one or more retrofit electrical loads, and supply power based on the converted voltage to the one or more retrofit electrical loads. For example, the one or more retrofit electrical loads may include household appliances, such as a portable refrigerator-freezer connected to an AC 100 V outlet provided in the vehicle 30.

The auxiliary DC-DC converter 43 is configured to convert high-voltage power, which is the voltage, i.e., the high voltage across the high-voltage battery 34, into low-voltage power with a predetermined low voltage, such as DC 12 V or DC 48 V. The auxiliary DC-DC converter 43 is configured to supply the converted low-voltage power to each of auxiliaries, which are a plurality of general electric loads of the vehicle 30.

The charger 44 includes a charging socket into which a charging plug for supplying power from outside the vehicle 30 to the vehicle 30 is insertable, and an electric circuit for controlling the supply of the electric power. The charger 44 is configured to adjust the voltage of the power supplied from outside the vehicle 30 and thereafter supply the adjusted power to the high-voltage battery 34. This enables the high-voltage battery 34 to be charged.

The high-voltage battery 34, the motor 35, the drive inverter 36, the refrigeration cycle system 37, the electric compressor 38, the water circuit system 39, the electric heater 40, the retrofit load inverter 42, the auxiliary DC-DC converter 43, and the charger 44 described above are each electrically connected to the in-vehicle computer 32.

The in-vehicle computer 32 is configured to output control signals indicating final command values to the controlled devices while preventing insufficient battery charge of the vehicle 30.

The HMI unit 45 is comprised of an interface unit 45a and a controller 45b having an input function of inputting, through the interface unit 45a, various data items from the occupant 80 as a user, and an output function of providing, through the interface unit 45a, various information the occupant 80. Examples of the HMI unit 45 include, as the interface unit 45a, a touch-panel display having a display function as the output function and the input function, and is provided on an instrument panel in the cabin 30a.

Examples of the input information, which is input from the occupant 80 through the interface unit 45a of the HMI unit 45, include a destination to be used for travel planning by the cloud computer 52, which will be described later, and requests of the occupant 80 related to the travel planning. Examples of the requests of the occupant 80 include a desired value for the remaining energy of the high-voltage battery 34 when the vehicle 30 arrives at the destination, or a desired level of the remaining energy of the high-voltage battery 34, such as low, medium, or high.

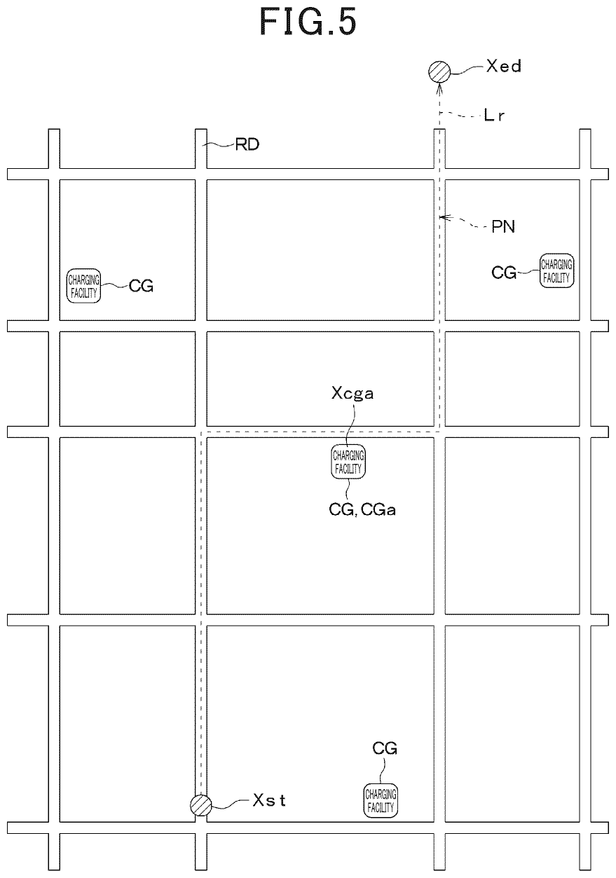

Examples of the output information, which is output through the interface unit 45a of the HMI unit 45 to the occupant 80, include information indicating a recommended travel route in the travel planning. Additionally, examples of the output information, which is output through the interface unit 45a of the HMI unit 45 to the occupant 80, include respective positions of charging facilities CG (see FIG. 5) available in the travel planning and a sequence of a target speed Vct of the vehicle 30 to be used in the travel planning.

A travel plan to be prepared and determined by the cloud computer 52 will also be referred to as a travel plan PN.

Information that is to be provided to the in-vehicle computer 32 without being provided to the occupant 80 is transmitted from the cloud 50 to the vehicle 30, so that the information is received by the in-vehicle computer 32. Examples of the information to be provided to the in-vehicle computer 32 include a target temperature for controlling the temperature of the high-voltage battery 34 in preparation for charging the high-voltage battery 34. The remaining energy of the high-voltage battery 34 will also be referred to simply as a charging level or a charging remaining level of the high-voltage battery 34. The charging facilities CG will also be referred to as charging stations. The high-voltage battery 34 can be charged from the charger 44 illustrated in FIG. 2 at each of the charging facilities CG.

The vehicle 30 further includes an information acquisition unit 90. The information acquisition unit 90 is connected to the in-vehicle computer 32 and the communication device 33, and is configured to acquire vehicle state information, such as a vehicle speed, a current vehicle position, or a battery state, from at least one of various sensors VS, a navigation device ND, GPS (Global Positioning System), or an API service 54 provided in the cloud 50. API is an abbreviation of “Application Programming Interface.”

The manager 51 of the cloud 50 functions to aggregate information transmitted and received among (i) the communication device 33 of the vehicle 30, (ii) an API service 54 provided in the cloud 50, and (iii) the cloud computer 52. The cloud computer 52 is configured to receive various information, which include the information input from the HMI unit 45 via the manager 51, and, for example, calculate a travel plan related to energy of the vehicle 30 traveling to the occupant's requested destination in accordance with an occupant's purpose. If information regarding the vehicle 30 is required for the calculation of the travel plan, the information is transmitted as appropriate from the vehicle 30 to the cloud 50. For example, the information can be inputted from the HMI unit 45 to the could 52 set forth above.

Examples of the information regarding the vehicle 30 include various information items respectively indicating (i) a present level of the remaining energy of the high-voltage battery 34, (ii) a value of the temperature of the high-voltage battery 34, and (iii) a current position Pa of the vehicle 30.

The API service 54 is, for example, implemented on a server in the cloud 50. When defining the API service 30 in the cloud 50, one of its functions is to act as a mechanism that allows hardware/software components within the cloud 50 to communicate with (i) other internal cloud components and (ii) external hardware/software components, through a predefined set of definitions and protocols.

For example, the current position Pa of the vehicle 30 may be obtained from the information acquisition unit 90, such as, at least one of the GPS, the navigation device ND of the vehicle 30, and the various sensors VS of the vehicle 30.

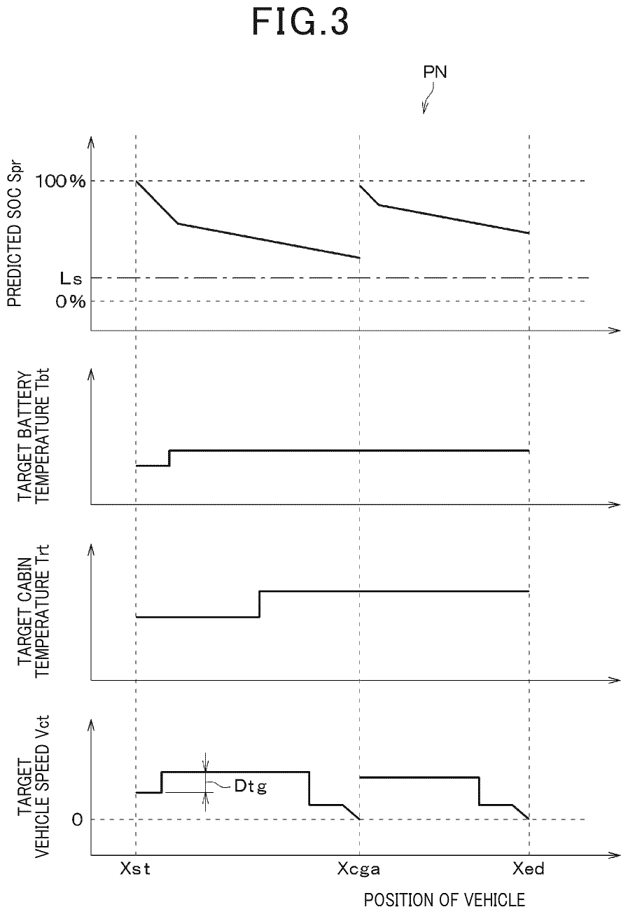

FIG. 3 illustrates a combination of graphs having a common horizontal axis that represents the position of the vehicle 30 on the scheduled travel route Lr, and vertical axes of the respective graphs indicate the target vehicle speed Vct, the target battery temperature Tbt, the target cabin temperature Trt, and the predicted charge rate, in other words, the state of charge (SOC), of the high-voltage battery 34, respectively

The travel plan PN calculated and completed by the cloud computer 52 is transmitted to the in-vehicle computer 32 via the manager 51, the cloud communication device 53, the wireless network NW, and the communication device 33. When functions related to calculation of the travel plan PN are distributed among a plurality of computers, the manager 51 also has a function of integrally controlling the plurality of computers. The travel plan PN corresponds to, for example, a plan of the present disclosure.

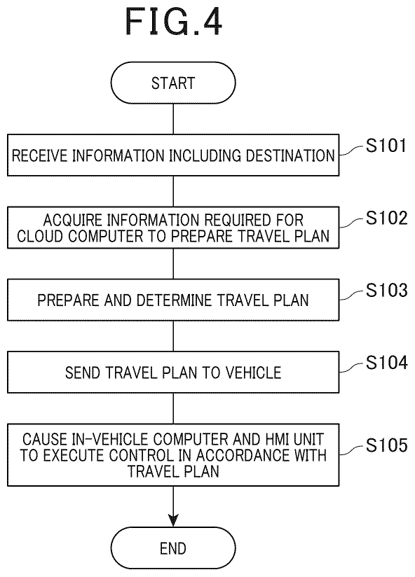

Specifically, the cloud computer 52 and the manager 51 of the cloud 52 are cooperatively configured to prepare a travel plan for the vehicle 30 in accordance with the flowchart illustrated in FIG. 4. The cloud computer 52 is configured to start the control routine illustrated in the flowchart of FIG. 4 in response to occupant's manual operations through the HMI unit 45. The travel plan PN is a plan of travel of the vehicle 30 that is determined prior to actual travel of the vehicle 30.

As illustrated in FIGS. 3 and 5, the travel plan PN is comprised of a plurality of information items including, for example, (i) a scheduled travel route Lr recommended in the travel plan, (ii) at least one charging facility CG selected to be stopped during the scheduled travel route Lr, (iii) a transition of the target speed Vct of the vehicle 30 during travelling of the vehicle 30, and (iv) a transition of the target temperature of each in-vehicle device. The at least one charging facility CG will also be referred to as at least one stop-off charging facility CGa.

Specifically, the travel plan PN according to the first embodiment includes
(I) The scheduled travel route Lr
(II) The information on the at least one stop-off charging facility CGa
(III) The transition of the target speed Vct of the vehicle 30 from the start point (see reference character Xst) to the end point (see reference character Xed) of the scheduled travel route Lr
(IV) The transition of the target cabin temperature Trt from the start point Xst to the end point Xed of the scheduled travel route Lr
(V) The transition of the target battery temperature Tbt from the start point Xst to the end point Xed of the scheduled travel route Lr
(VI) The transition of the predicted SOC of the high-voltage battery 34 from the start point Xst to the end point Xed of the scheduled travel route Lr

The target vehicle speed Vct denotes a target value of the speed of the vehicle 30, the target cabin temperature Trt denotes a target value of the temperature in the cabin 30a of the vehicle 30, which is to be adjusted by air-conditioning in the cabin 30a. The target battery temperature Tbt denotes a target value of the temperature of the high-voltage battery 34. The predicted SOC of the high-voltage battery 34 denotes a predicted value of the SOC of the high-voltage battery 34, which is predicted by the cloud computer 52.

When starting the control routine, the cloud computer 52 receives information, which is input thereto by occupant's information input operations through the HMI unit 45 in step S101. The information input operations by the occupant 80 herein means that the occupant 80 inputs, through the interface unit 45a of the HMI unit 45, information to the controller 45b of the HMI unit 45; the cloud computer 52 is configured to refer to the input information for performing a travel-plan preparation. For example, as the information input operations, the occupant 80 inputs, through the interface unit 45a of the HMI unit 45, a destination of a travel plan.

In addition, the occupant 80 may also input, through the interface unit 45a of the HMI unit 45, (i) a desired value of the remaining energy of the high-voltage battery 34 or a desired level of the remaining energy when the vehicle 30 arrives at the destination, (ii) permission or prohibition of use of toll roads in the travel plan, and (iii) preference information indicating preferences of the occupant 80.

Examples of the preference information include information on the adjustment of the strength of air conditioning in the cabin 30a and/or information indicative of whether priority is given to travel time or to energy efficiency in the travel planning.

Various methods of occupant's input operations through the interface unit 45a of the HMI unit 45 for example include, when a touch panel display is provided as the interface unit 45a, occupant's operation of one or more visual switches and/or one or more extendable visual bars displayed on the touchscreen of the touch panel display. The input information entered into the controller 45b of the HMI unit 45 is transmitted from the controller 45b to the cloud computer 52 via the communication device 33 and the wireless network NW.

After the operation in step S101 of FIG. 4, the control routine proceeds to step S102.

In step S102, the cloud computer 52 acquires travel-plan basic information, which is information required to determine (i) a scheduled travel route Lr, which is illustrated in, for example, FIG. 4, in a travel plan PN of the vehicle 30, (ii) a sequence of target vehicle speeds during travel of the vehicle 30, and (iii) a sequence of target temperatures of each in-vehicle device. Examples of the travel plan basic information include the information including the current position Pa of the vehicle 30 and the destination entered in step S101 and the external information; the external information includes (i) information indicative of the ambient temperature around the vehicle 10 and (ii) information indicative of traffic congestion around the vehicle 30.

Examples of the travel plan basic information further include vehicle information indicating a condition of the vehicle 30, such as at least one of vehicle-speed information indicating the speed of the vehicle 30 and battery information indicating the present state (for example, the SOC and temperature) of the high-voltage battery 34.

In step S102, the cloud computer 52 obtains, from, for example, the API service 54, the external information.

FIG. 5 illustrates, in addition to a scheduled travel route Lr whose traveling direction is shown by the arrow, roads RD around the vehicle 30, charging facilities CG at which the vehicle 30 can be charged, and a current position Pa of the vehicle 30 (i.e., a vehicle current position Pa).

After the operation in step S102 of FIG. 4, the control routine proceeds to step S103.

In step S103, the cloud computer 52 prepares and determines the travel plan PN, which includes the scheduled travel route Lr, of the vehicle 30 based on the travel plan basic information acquired in step S102. For example, the cloud computer 52 determines the travel plan PN using, for example, a known optimization algorithm. For example, when a plurality of travel-route candidates are provided by the existing API service 54, the cloud computer 52 selects one travel-route candidate from the plurality of travel-plan candidates, and determines the selected travel-route candidate as the scheduled travel route Lr of the travel plan.

The scheduled travel route Lr along which the vehicle 30 is going to travel from the current position Pa to the destination is comprised of a plurality of predetermined sections.

The start point Xst of the scheduled travel route Lr is set to the current position Pa of the vehicle 30, and the end point Xed of the scheduled travel route Lr is set to the destination that is input by the occupant 80.

In step S103, the cloud computer 52 determines, as components of the travel plan PN, (i) at least one charging facility CG at which the vehicle 30 can stop along the scheduled travel route Lr for battery charging as at least one stop-off charging facility CGa, and (ii) the amount of charging energy at the at least one stop-off charging facility CGa.

Additionally, in step S103, the cloud computer 52 determines, as components of the travel plan PN, various parameters, which include, for example, (i) a sequence of values of the target vehicle speed Vct at the respective sections of the scheduled travel route Lr, (ii) a sequence of values of the target battery temperature Trt at the respective sections of the scheduled travel route Lr, and (iii) a sequence of values of the target cabin temperature Tbt at the respective sections of the scheduled travel route Lr. An evaluation function is defined for the various parameters such that a higher evaluation corresponds to a larger value, and the various parameters are determined so that the evaluation function value is maximized. Examples of the evaluation function include a function defined to increase with improvement of travel time, energy efficiency, remaining energy of the high-voltage battery 34, and/or risk of insufficient battery charge.

In particular, the cloud computer 52 determines the travel plan PN that enables the vehicle 30 to travel based on the travel plan PN while ensuring that the SOC of the high-voltage battery 34 remains not less than a predetermined allowable lower limit Ls (see FIG. 3) in step S103. More specifically, the cloud computer 52 calculates a sequence of values of the predicted SOC Spr of the high-voltage battery 34 at the respective sections of the scheduled travel route Lr from the start point Xst to the end point Xed (see FIG. 3) in step S103. Then, the cloud computer 52 determines the travel plan PN such that all the values of the predicted SOC Spr of the high-voltage battery 34 remain not less than the predetermined allowable lower limit Ls.

For example, the cloud computer 52 calculates, for each section of the scheduled travel route Lr, the predicted SOC Spr based on (i) a travel energy efficiency, i.e., energy consumption rate, of the vehicle 30, (ii) the scheduled travel route Lr, and (iii) the corresponding value of the target cabin temperature Trt. The travel energy efficiency of the vehicle 3, expressed in, for example, kilometers per kilowatt-hour (km/kWh), denotes the distance the vehicle 30 can travel for each unit of electrical energy consumed. The allowable lower limit Ls may be experimentally set in advance to a fixed value that prevents insufficient battery charge of the vehicle 30 or a value variable depending on the preference information on the occupant 80 acquired in step S102.

After the operation in step S103 of FIG. 4, the control routine proceeds to step S104.

In step S104, the cloud computer 52 sends the travel plan PN determined in step S103 as illustrated in FIGS. 3 and 5 to the manager 51, and the manager 51 transmits the travel plan to the vehicle 30 via the wireless network NW.

The travel plan PN includes, in addition to the scheduled travel route Lr, for example, (i) a position Xcga of the at least one stop-off charging facility CGa at which the vehicle 30 can stop along the scheduled travel route Lr for battery charging, (ii) the amount of charging energy at the at least one stop-off charging facility CGa, (iii) the sequence of values of the target vehicle speed Vct at the respective sections of the scheduled travel route Lr, (iv) the sequence of values of the target cabin temperature Trt at the respective sections of the scheduled travel route Lr, (v) the sequence of values of the target battery temperature Tbt at the respective sections of the scheduled travel route Lr, and (vi) the sequence of values of the predicted SOC Spr of the high-voltage battery 34 at the respective sections of the scheduled travel route Lr.

After the operation in step S104 of FIG. 4, the control routine proceeds to step S105.

In step S105, the manager 51 causes the in-vehicle computer 32 and the HMI unit 45 to execute control in accordance with the travel plan PN. For example, this enables the in-vehicle computer 32 to start autonomous driving of the vehicle 30 in accordance with the travel plan PN in response to receiving a predetermined driver's manual operation of the interface unit 45a of the HMI unit 45. The autonomous driving of the vehicle 30 is, for example, any one of level-3, level-4, and level-5 automated driving in which the in-vehicle computer 32 autonomously controls the speed and steering of the vehicle 30 in accordance with the travel plan PN.

Specifically, when starting the autonomous driving of the vehicle 30, the in-vehicle computer 32 controls both the motor 35 and the drive inverter 36 to cause the vehicle 30 to travel such that the speed of the vehicle 30 approaches the sequence of the values of the target vehicle speed Vct of the travel plan PN. In other words, the in-vehicle computer 32 controls both the motor 35 and the drive inverter 36 to cause the vehicle 30 to travel such that the speed of the vehicle 30 at each section of the scheduled travel route Lr becomes the corresponding value of the target vehicle speed Vct of the travel plan PN at the corresponding section. Additionally, when starting the autonomous driving of the vehicle 30, the in-vehicle computer 32 controls the temperature control apparatus 46 such that the temperature in the cabin 30a approaches the sequence of the values of the target cabin temperature Trt of the travel plan PN. In other words, the in-vehicle computer 32 controls the temperature control apparatus 46 such that the temperature in the cabin 30a at each section of the scheduled travel route Lr becomes the corresponding value of the target cabin temperature Trt of the travel plan PN at the corresponding section. Similarly, when starting the autonomous driving of the vehicle 30, the in-vehicle computer 32 controls the temperature control apparatus 46 such that the temperature of the high-voltage battery 34 approaches the sequence of the values of the target battery temperature Tbt of the travel plan PN. In other words, the in-vehicle computer 32 controls the temperature control apparatus 46 such that the temperature of the high-voltage battery 34 at each section of the scheduled travel route Lr becomes the corresponding value of the target battery temperature Tbt of the travel plan PN at the corresponding section.

As described above, the speed of the vehicle 30 and the temperature of the high-voltage battery 34 are automatically controlled during autonomous driving of the vehicle 34. Additionally, each of the target vehicle speed Vct, the target cabin temperature Trt, and the target battery temperature Tbt is automatically controlled in accordance with the travel plan PN. The cabin 30a of the vehicle 30 corresponds to a predetermined portion of the vehicle 30 according to the present disclosure, and the temperature in the cabin 30a corresponds to the temperature of the predetermined portion of the vehicle 30 according to the present disclosure.

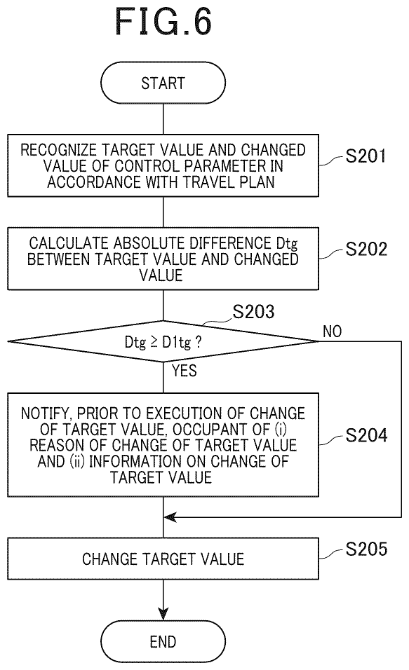

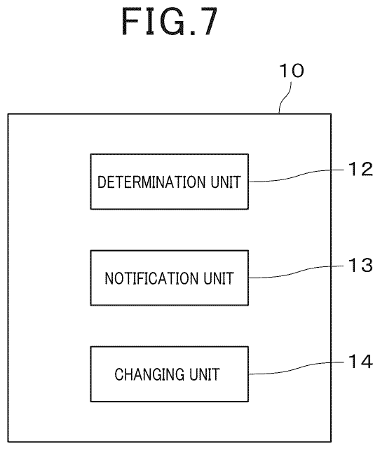

The notification system 10 of the first embodiment functionally includes, for execution of a notification control routine illustrated as a flowchart in FIG. 6, a determination unit 12, a notification unit 13, and a changing unit 14 (see FIG. 7). The determination unit 12, the notification unit 13, and the changing unit 14 according to the first embodiment are included in the manager 51, which serves as, for example, control circuitry, of the cloud 50 in the notification system 10.

The notification system 10 is configured to execute the notification control routine illustrated in FIG. 6 for each of the target vehicle speed Vct and the target cabin temperature Trt. Specifically, the notification system 10 is configured to execute (i) the notification control routine for the target vehicle speed Vct illustrated in FIG. 6 and (ii) the notification control routine for the target cabin temperature Trt in parallel to one another. The notification control routine for the target vehicle speed Vct illustrated in FIG. 6 and the notification control routine for the target cabin temperature Trt are substantially identical to one another except that a target parameter, i.e., the target vehicle speed Vct, handled in the notification control routine for the target vehicle speed Vct is different from that, i.e., the target cabin temperature Trt, handled in the notification control routine for the target cabin temperature Trt.

The following describes the notification control routine for the target vehicle speed Vct illustrated in FIG. 6 first. The manager 51 is configured to execute the notification control routine for the target vehicle speed Vct illustrated in FIG. 6 each time the target vehicle speed Vct is changed in accordance with the travel plan PN after start of the autonomous driving of the vehicle 30 based on the travel plan PN. For example, the manager 51 is configured to recognize target-speed change timings based on the current position Pa of the vehicle 30 and the travel plan PN, and therefore start the notification control routine for the target vehicle speed Vct illustrated in FIG. 6 at any timing before each target-speed change timing.

When starting the notification control routine for the target vehicle speed Vct illustrated in FIG. 6, the determination unit 12 recognizes whether a target value of a control parameter that is the target vehicle speed Vct used for the autonomous-driving control carried out in accordance with the travel plan PN is scheduled for a change in step S201. For example, the determination unit 12 recognizes whether the target value of the control parameter is scheduled for a change based on, for example, the current position Pa of the vehicle 30 and the travel plan PN. In response to determination that the target value of the control parameter is scheduled for a change, the determination unit 12 recognizes the target value of the control parameter and a changed target value of the control parameter in step S201. Specifically, the target value of the control parameter is a current value of the target vehicle speed Vct and the changed target value of the control parameter is a changed value of the target vehicle speed Vct.

The operation in step S201 is completed so that a notification operation in later step S204 can be carried out with sufficient lead time before the timing of changing the target value of the control parameter according to the travel plan PN. The target value of the control parameter, which has not been changed yet, will also be referred to as a current target value of the control parameter. After the operation in step S201 of FIG. 6, the notification control routine proceeds to step S202.

The determination unit 12 calculates an absolute difference Dtg, in other words, an absolute target-value difference Dtg, between the current target value and the changed target value of the control parameter, i.e., between the current value of the target vehicle speed Vct and the changed value of the target vehicle speed Vct in step S202. An example of the absolute target-value difference Dtg is illustrated in FIG. 6. After the operation in step S202 of FIG. 6, the notification control routine proceeds to step S203.

The determination unit 12 determines whether the absolute target-value difference Dtg is greater than or equal to a predetermined threshold D1tg in step S203.

Specifically, the determination unit 12 determines whether an absolute target vehicle-speed difference, which corresponds to the absolute target-value difference Dtg, between the current value of the target vehicle speed Vct and the changed value of the target vehicle speed Vct is greater than or equal to a predetermined target vehicle-speed threshold corresponding to the predetermined threshold D1tg.

In other words, the determination unit 12 determines whether the target value of the control parameter (i.e., the current value of the target vehicle speed Vct) needs to be changed by the absolute difference Dtg (i.e., the absolute target vehicle-speed difference) in accordance with the travel plan PN; the absolute difference (i.e., the absolute target vehicle-speed difference) is not less than the predetermined threshold D1tg (i.e., the predetermined target vehicle-speed threshold).

Because the predetermined target vehicle-speed threshold corresponds to the predetermined threshold D1tg, the predetermined target vehicle-speed threshold denotes a determination threshold determined as the threshold D1tg. The threshold D1tg is experimentally set in advance to the lower limit of the absolute target-value difference Dtg that causes the occupant 80 to feel a sense of discomfort.

The scheduled automatic change of the target value of the control parameter, in accordance with the travel plan PN, by the absolute difference Dtg that is not less than the predetermined threshold D1tg corresponds to a predetermined change related to the travel plan PN according to the present disclosure.

In other words, the scheduled automatic change of the current value of the target vehicle speed Vct, in accordance with the travel plan PN, by the absolute target vehicle-speed difference that is not less than the predetermined target vehicle-speed threshold corresponds to the predetermined change related to the travel plan PN according to the present disclosure. Accordingly, the above determination in step S203 is equivalent to the determination as to whether the predetermined change related to the travel plan PN needs to be executed.

In response to determination that the absolute target-value difference Dtg is greater than or equal to the predetermined threshold D1tg, in other words, the absolute target vehicle-speed difference between the current value of the target vehicle speed Vct and the changed value of the target vehicle speed Vct is greater than or equal to the predetermined target vehicle-speed threshold (YES in step S203), the notification control routine proceeds to step S204.

Otherwise, in response to determination that the absolute target-value difference Dtg is smaller than the predetermined threshold D1tg, in other words, the absolute target vehicle-speed difference between the current value of the target vehicle speed Vct and the changed value of the target vehicle speed Vct is smaller than the predetermined target vehicle-speed threshold (NO in step S203), the notification control routine proceeds to step S205.

Following the affirmative determination in step S203, the notification unit 13 notifies, prior to execution of the change of the target value of the control parameter by the absolute difference Dg that is not less than the predetermined threshold D1tg, the occupant 80 of (i) one or more reasons that the above change is to be executed and (ii) information on the above change in step S204.

Specifically, the notification unit 13 notifies, prior to execution of the change of the current value of the target vehicle speed Vct by the absolute target vehicle-speed difference that is not less than the predetermined target vehicle-speed threshold, the occupant 80 of (i) the one or more reasons that the above change is to be executed and (ii) information on the above change in step S204.

For example, the notification unit 13 estimates, based on information related to the scheduled travel route Lr (such as a sequence of variations in the speed limit along the route Lr and/or a variation in the SOC of the high-voltage battery 34), the one or more reasons that include (i) a change of the speed limit on a road RD included in the scheduled travel route Lr on which the vehicle 30 is traveling, and/or (ii) maintenance of the SOC of the high-voltage battery 34 at not less than a predetermined level, in step S204.

The information on the above target-value change is estimated as an increase or a decrease in the target value of the control parameter.

Notifying the occupant 80 of the information on the above target-value change enables the occupant 80 to identify what physical quantity the target value of the control parameter represents. That is, notifying the occupant 80 of the information on the above target-value change enables the occupant 80 to identify whether the control parameter whose target value is to be changed is the target vehicle speed Vct or the target cabin temperature Trt. More specifically, the notifying unit 13 notifies the occupant 80 that the target vehicle speed Vct is scheduled to increase or decrease when the control parameter is the target vehicle speed Vct.

For example, the notification unit 13 performs the notification in step S204 using, for example, at least one of sound and visual indication. Specifically, the notification unit 13 operates a notification device 451 included in the HMI unit 45 to accordingly provide m the notification through the notification device 451. This enables the notification to be provided to the occupant 80 in the form of, for example, at least one of sound and visual indication.

For example, if the notification to be provided to the occupant 80 is designed to be in the form of sound, the notification device 451 includes a speaker, and the notification unit 13 operates the speaker of the notification device 451 to output sound indicative of the notification through the speaker.

As another example, if the notification to be provided to the occupant 80 is designed to be in the form of visual indication, the notification device 451 includes a display, such as a monitor, the notification unit 13 operates the display of the notification device 451 to output visual information indicative of the notification through the display.

The operation in step S204 is completed with predetermined margin time before the timing of changing the target value of the control parameter, i.e., the timing of changing the current value of the target vehicle speed Vct in later step S205. The predetermined margin time denotes a time period for avoiding a sense of discomfort that the occupant 80 may feel due to an abrupt change of the target vehicle speed Vct in step S205. The margin time may be, for example, several to a dozen seconds, does not need to be strictly fixed, and may have a certain range.

Because the notification unit 13 is capable of recognizing, based on the current position Pa of the vehicle 30 and the travel plan PN, change timings of the target speed Vct, the notification unit 13 makes it possible to complete the operation in step S204 with the predetermined margin time before the timing of changing the current value of the target vehicle speed Vct. After the operation in step S204 of FIG. 6, the notification control routine proceeds to step S205.

In step S205, the changing unit 14 of the manager 51 changes the target value of the control parameter, i.e., the current value of the target vehicle speed Vct, in accordance with the travel plan PN. Because the speed of the vehicle 30 is controlled to approach the target vehicle speed Vct, the speed of the vehicle 30 is changed to follow the change of the target vehicle speed Vct.

The notification control routine for the target vehicle speed Vct illustrated in FIG. 6 is configured to determine whether to execute a notification to the occupant 80 depending on the result of the determination in step S203.

Specifically, in response to determination that the absolute target vehicle-speed difference between the current value of the target vehicle speed Vct and the changed value of the target vehicle speed Vct is greater than or equal to the predetermined target vehicle-speed threshold, the notification control routine for the target vehicle speed Vct is configured to perform, prior to execution of the change of the target vehicle speed Vct, a notification to the occupant 80; the notification indicates that change of the target vehicle speed Vct.

Otherwise, in response to determination that the absolute target vehicle-speed difference between the current value of the target vehicle speed Vct and the changed value of the target vehicle speed Vct is less than the predetermined target vehicle-speed threshold, the notification control routine for the target vehicle speed Vct is configured to change the current value of the target vehicle speed Vct in accordance with the travel plan PN without executing a notification in step S204.

Next, the following describes the notification control routine for the target cabin temperature Trt illustrated in FIG. 6. As described above, the notification control routine for the target cabin temperature Trt illustrated in FIG. 6 is substantially identical to that for the target vehicle speed Vct illustrated in FIG. 6 except that the target parameter, i.e., the target cabin temperature Trt, handled in the notification control routine for the target cabin temperature Trt is different from that, i.e., the target vehicle speed Vct, handled in the notification control routine for the target vehicle speed Vct illustrated in FIG. 6.

When starting the notification control routine for the target cabin temperature Trt illustrated in FIG. 6, the determination unit 12 recognizes whether a target value of the control parameter that is the target cabin temperature Trt used for the autonomous-driving control carried out in accordance with the travel plan PN is scheduled for a change in step S201. In response to determination that the target value of the control parameter is scheduled for a change, the determination unit 12 recognizes the target value of the control parameter and a changed target value of the control parameter in step S201. Specifically, the target value of the control parameter is a current value of the target cabin temperature Trt and the changed target value of the control parameter is a changed value of the target cabin temperature Trt.

After the operation in step S201 of FIG. 6, the notification control routine proceeds to step S202.

The determination unit 12 calculates an absolute target-value difference Dtg between the current target value and the changed target value of the control parameter, i.e., an absolute target cabin-temperature difference between the current value of the target cabin temperature Trt and the changed value of the target cabin temperature Trt in step S202. After the operation in step S202 of FIG. 6, the notification control routine proceeds to step S203.

The determination unit 12 determines whether the absolute target-value difference Dtg is greater than or equal to a predetermined threshold D1tg in step S203. Specifically, the determination unit 12 determines whether the absolute target cabin-temperature difference between the current value of the target cabin temperature Trt and the changed value of the target cabin temperature Trt is greater than or equal to a predetermined target cabin-temperature threshold corresponding to the predetermined threshold D1tg. Because the predetermined target cabin-temperature threshold corresponds to the predetermined threshold D1tg, the predetermined cabin-temperature threshold denotes a determination threshold determined as the threshold D1tg. The threshold D1tg is experimentally set in advance to the lower limit of the absolute target-value difference Dtg that causes the occupant 80 to feel a sense of discomfort.

In response to determination that the absolute target cabin-temperature difference between the current value of the target cabin temperature Trt and the changed value of the target cabin temperature Trt is greater than or equal to the predetermined target cabin-temperature threshold (YES in step S203), the notification control routine proceeds to step S204.

In step S204, the notification unit 13 notifies, prior to execution of the change of the current value of the target vehicle speed Vct by the absolute target vehicle-speed difference not less than the predetermined target vehicle-speed threshold, the occupant 80 of (i) the one or more reasons that the above target cabin-temperature change is to be executed and (ii) information on the above target cabin-temperature change.

For example, the notification unit 13 estimates, based on information related to the scheduled travel route Lr (such as the sequence of variations in the speed limit along the route Lr and/or the variation in the SOC of the high-voltage battery 34), the one or more reasons that include maintenance of the SOC of the high-voltage battery 34 at not less than the predetermined level, in step S204.

After the operation in step S204 of FIG. 6, the notification control routine proceeds to step S205.

Otherwise, in response to determination that the absolute target cabin-temperature difference between the current value of the target cabin temperature Trt and the changed value of the target cabin temperature Trt is smaller than the predetermined target cabin-temperature threshold (NO in step S203), the notification control routine proceeds to step S205 while skipping the operation in step S204.

In step S205, the changing unit 14 of the manager 51 changes the current value of the target cabin temperature Trt in accordance with the travel plan PN. Because the temperature in the cabin 30a is controlled to approach the target cabin temperature Trt, the temperature in the cabin 30a is changed to follow the change of the target cabin temperature Trt.

In the notification control routine illustrated in FIG. 6 for the target cabin temperature Trt, the scheduled automatic change of the current value of the target cabin temperature Trt, in accordance with the travel plan PN, by the absolute target cabin-temperature difference not less than the predetermined target cabin-temperature threshold corresponds to the predetermined change related to the travel plan PN according to the present disclosure. Accordingly, the above determination in step S203 is equivalent to the determination as to whether the predetermined change related to the travel plan PN needs to be executed.

The following describes advantageous benefits achieved by the notification system 10 according to the first embodiment.

The determination unit 12 of the notification system 10 according to the first embodiment is configured to determine whether the predetermined change related to the travel plan PN needs to be executed.

The predetermined change related to the travel plan PN according to the first embodiment denotes at least one of:
(I) The scheduled automatic change of the current value of the target vehicle speed Vct, in accordance with the travel plan PN, by the absolute target vehicle-speed difference that is not less than the predetermined target vehicle-speed threshold in the notification control routine for the target vehicle speed Vct illustrated in FIG. 6;

(II) The scheduled automatic change of the current value of the target cabin temperature Trt, in accordance with the travel plan PN, by the absolute target cabin-temperature difference that is not less than the predetermined target cabin-temperature threshold in the notification control routine for the target cabin temperature Trt illustrated in FIG. 6.

In response to determination that the predetermined change related to the travel plan PN needs to be executed, the notification unit 13 according to the first embodiment is configured to notify, prior to execution of the predetermined change related to the travel plan PN, the occupant 80 of (i) one or more reasons that the predetermined change related to the travel plan PN is to be executed and (ii) information on the predetermined change related to the travel plan PN.

This configuration of the notification system 10 enables the occupant 80 to recognize, prior to execution of the predetermined change related to the travel plan PN, that (i) the predetermined change related to the travel plan PN is to be executed and (ii) the one or more reasons of the execution of the predetermined change related to the travel plan PN in accordance with the notification performed by the notification unit 13.

This configuration of the notification system 10 therefore makes it possible to reduce, even if the execution of the predetermined change related to the travel plan PN is not intended by the occupant 80, an occupant's discomfort due to the occurrence of the predetermined change related to the travel plan PN.

This configuration of the notification system 10 additionally enables the occupant 80 to recognize the one or more reasons that the predetermined change related to the travel plan PN is to be executed prior to execution of the predetermined change related to the travel plan PN, making it possible to further reduce an occupant's discomfort due to the occurrence of the predetermined change related to the travel plan PN as compared with a simple prior notification, such as a buzzer-sound output or a blinking-mark display.

The vehicle 30 to which the notification system 10 is to be applied is, for example, an electric vehicle according to the first embodiment. The travel plan PN is, as illustrated in FIG. 3, designed to enable the vehicle 30 to travel while ensuring that the SOC of the high-voltage battery 34 remains not less than the predetermined allowable lower limit Ls. This therefore makes it possible to perform the travel plan PN while preventing insufficient battery charge of the vehicle 30.

The notification unit 13 of the notification system 10 according to the first embodiment is configured to execute the notification using at least one of sound and visual indication in step S204 of the notification control routine illustrated in FIG. 6. This configuration therefore enables the occupant 80 to recognize the information indicated by the notification immediately after the execution of the notification.

The notification control routine for the target vehicle speed Vct illustrated in FIG. 6 is configured to determine whether the predetermined change related to the travel plan PN needs to be executed; the predetermined change related to the travel plan PN denotes the scheduled automatic change of the current value of the target vehicle speed Vct, in accordance with the travel plan PN, by the absolute target vehicle-speed difference that is not less than the predetermined target vehicle-speed threshold.

This configuration therefore enables the occupant 80 to recognize, based on the notification executed by the notification unit 13, that (i) information indicative of the target vehicle speed Vct being to be changed and (ii) the reason that the target vehicle speed Vct is to be changed prior to execution of the change of the target vehicle speed Vct. This therefore makes it possible to reduce, even if the vehicle speed control to follow the change of the target vehicle speed Vct is not intended by the occupant 80, an occupant's discomfort due to the occurrence of the change of the speed of the vehicle 30.

The notification control routine for the target cabin temperature Trt illustrated in FIG. 6 is configured to determine whether the predetermined change related to the travel plan PN needs to be executed; the predetermined change related to the travel plan PN denotes the scheduled automatic change of the current value of the target cabin temperature Trt, in accordance with the travel plan PN, by the absolute target cabin-temperature difference that is not less than the predetermined target cabin-temperature threshold.

This configuration therefore enables the occupant 80 to recognize, based on the notification executed by the notification unit 13, that (i) information indicative of the target cabin temperature Trt being to be changed and (ii) the reason that the target cabin temperature Trt is to be changed prior to execution of the change of the target cabin temperature Trt. This therefore makes it possible to reduce, even if the cabin temperature control to follow the change of the target cabin temperature Trt is not intended by the occupant 80, an occupant's discomfort due to the occurrence of the change of the temperature in the cabin 30a of the vehicle 30.

The temperature in the cabin 30a according to the first embodiment corresponds to the temperature at the predetermined portion of the vehicle 30. That is, the predetermined portion of the vehicle 30 indicates a portion in the vehicle 30 whose temperature variation is transferred to the occupant 80. The notification control routine is carried out for the target cabin temperature Trt, which is the target temperature in the cabin 30a. Accordingly, if there is a possibility that automatic temperature change in the cabin 30a causes discomfort to the occupant 80, this configuration makes it possible to appropriately notify the occupant 80 of information indicative of the possibility in step S204 of the notification control routine.

The notification executed in step S204 of the notification control routine for each of the target vehicle speed Vct and the target cabin temperature Trt is completed with predetermined margin time before the timing of changing the current value of the corresponding one of the target vehicle speed Vct and the target cabin temperature Trt in step S205. This therefore makes it possible to reduce a possibility that the occupant 80 feels the occurrence of an abrupt change of the corresponding one of the target vehicle speed Vct and the target cabin temperature Trt.

### Second Embodiment

Next, the following describes the second embodiment of the present disclosure. In particular, the following mainly describes different points of the second embodiment, which are different from the first embodiment.

The description of the same or equivalent components as those in the aforementioned first embodiment will be omitted or simplified. This also applies to the description of the later-described embodiments and modifications.

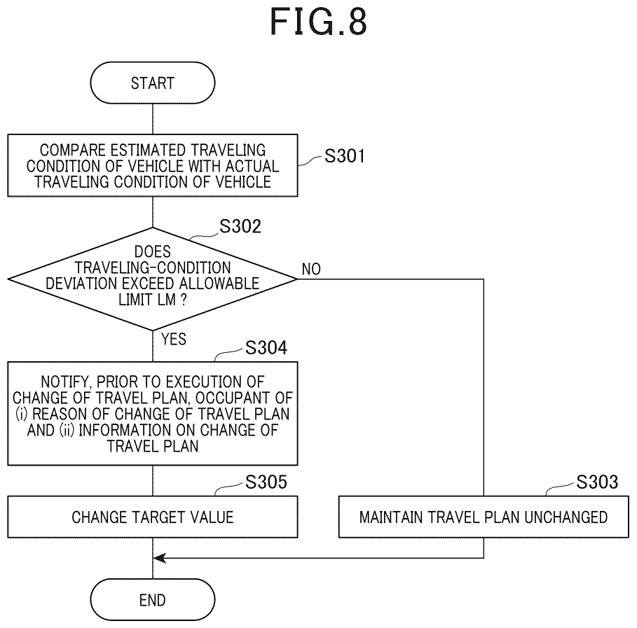

The notification system 10 according to the second embodiment is configured to execute a notification control routine illustrated in FIG. 8 in place of that illustrated in FIG. 6. For example, the manager 51 is configured to cyclically execute the notification control routine illustrated in FIG. 8 in response to start of the autonomous driving of the vehicle 30 based on the travel plan PN.

Note that the control routine illustrated in FIG. 4 is carried out in the second embodiment in the same manner as that in the first embodiment, so that the travel plan PN according to the second embodiment is determined by the control routine illustrated in FIG. 4. Additionally, the notification system 10 functionally includes, as illustrated in FIG. 7, a determination unit 12, a notification unit 13, and a changing unit 14. The determination unit 12, the notification unit 13, and the changing unit 14 according to the second embodiment are included in the manager 51, which serves as, for example, control circuitry, of the cloud 50 in the notification system 10.

When starting the notification control routine illustrated in FIG. 8, the determination unit 12 acquires, from the travel plan PN, an estimated traveling condition of the vehicle 30 at a present point of time and acquires an actual traveling condition of the vehicle 30 at the present point of time in step S301, and compares the estimated traveling condition of the vehicle 30 with the actual traveling condition of the vehicle 30 at the present point of time in step S301.

Specifically, the determination unit 12 acquires, from the travel plan PN, an estimated value of each of traveling-condition parameters including, for example, (i) the SOC of the high-voltage battery 34 at the present point of time, (ii) the speed of the vehicle 30 at the present point of time, and (iii) the position of the vehicle 30 at the present point of time. Additionally, the determination unit 12 acquires, from the various sensors VS of the vehicle 30 and/or the navigation device NV of the vehicle 30, an actual value of each of traveling-condition parameters.

An example of the method of comparing, for each traveling-condition parameter, the estimated value at the present point of time with the actual value at the present point of time is to calculate, as an evaluation score for each traveling-condition parameter, a deviation of the actual value from the corresponding estimated value. Then, the method calculates, as a total score, the sum of the evaluation scores of all the traveling-condition parameters to accordingly recognize that, the greater the total score is, the wider the deviation of the actual traveling condition of the vehicle 30 at the present point of time from the estimated traveling condition of the vehicle 30 at the present point of time is.

For example, the greater the deviation of the actual value of the SOC of the high-voltage battery 34 from a corresponding value of the predicted SOC Spr thereof is, the higher the evaluation score of the SOC of the high-voltage battery 34 as the traveling-condition parameter is. As another example, as the distance between the actual value of the vehicle 30 and the estimated value of the position of the vehicle 30 on the scheduled travel route Lr increases, the evaluation score of the position of the vehicle 30 on the scheduled travel route Lr is. Following the operation in step S301, the notification control routine proceeds to step S302.

In step S302, the determination unit 12 determines whether a deviation, i.e., a traveling-condition deviation, of the actual traveling condition of the vehicle 30 at the present point of time from the estimated traveling condition of the vehicle 30 at the present point of time exceeds a predetermined allowable limit LM. The allowable limit LM is experimentally set in advance to enable a determination as to whether the travel plan PN needs to be changed, i.e., updated.

To sum up, the determination unit 12 compares the travel plan PN with the actual traveling condition of the vehicle 30 at the present point of time to accordingly determine whether the travel plan PN needs to be changed, i.e., updated in step S302.

Specifically, the determination unit 12 determines whether the total score calculated in step S301 is higher than a predetermined determination threshold corresponding to the allowable limit LM, and determines that the traveling-condition deviation at the present point of time exceeds the allowable limit LM in response to determination that the total score calculated in step S301 is higher than the predetermined determination threshold in step S302.

For example, if the vehicle 30 travels while deviating from the scheduled travel route Lr of the travel plan PN over a certain level of limit at the present point of time, the total score becomes higher than the predetermined determination threshold corresponding to the allowable limit LM, so that the determination unit 12 determines that the traveling-condition deviation at the present point of time exceeds the allowable limit LM. As another example, if the actual value of the SOC of the high-voltage battery 34 at the present point of time is smaller than the corresponding value of the predicted SOC Spr thereof at the present point of time, so that it is predicted that the vehicle 30 cannot reach the stop-off charging facility CGa, the determination unit 12 determines that the traveling-condition deviation at the present point of time exceeds the allowable limit LM.

Specifically, in response to determination that the traveling-condition deviation does not exceed the allowable limit LM, so that the traveling-condition deviation is within the allowable limit LM (NO in step S302), the notification control routine proceeds to step S303. Otherwise, in response to determination that the traveling-condition deviation exceeds the allowable limit LM (YES in step S302), the notification control routine proceeds to step S304.

In response to determination that the traveling-condition deviation exceeds the allowable limit LM, the travel plan PN is going to be automatically changed in later step S305. Otherwise, in response to determination that the traveling-condition deviation is within the allowable limit LM, the travel plan PN is going to be maintained without being changed in later step S305. Accordingly, the determination unit 12 cyclically determines, in step S302, whether the travel plan PN needs to be automatically changed during traveling of the vehicle 30 based on the comparison between the travel plan PN and the actual traveling-condition of the vehicle 30.

The automatic change of the travel plan PN during traveling of the vehicle 30 corresponds to the predetermined change related to the travel plan PN according to the present disclosure according to the second embodiment. In other words, the determination unit 12 determines whether the predetermined change related to the travel plan PN needs to be executed in step S302 according to the second embodiment.

Following the negative determination in step S302, the changing unit 14 does not change the travel plan PN to maintain the travel plan PN unchanged in step S303. Thereafter, the current cycle of the notification control routine is terminated, and the next cycle of the notification control routine is started.

Following the affirmative determination in step 302, the notification unit 13 notifies, prior to execution of the change of the travel plan PN in later step S305, the occupant 80 of (i) one or more reasons that the travel plan PN needs to be changed and (ii) information on the change of the travel plan PN in step S304. Specifically, the notification unit 13

For example, as the one or more reasons, the notification unit 13 estimates, based on the comparison result in step S301, (i) a first situation where the vehicle 30 travels while deviating from the scheduled travel route Lr of the travel plan PN over the certain level of limit or (ii) a second situation where the actual value of the SOC of the high-voltage battery 34 is considerably smaller than the corresponding value of the predicted SOC Spr thereof based on the travel plan PN. That is, one or more causes related to change the travel plan PN is notified in step S304. The information on the change of the travel plan PN is estimated as an updating of the travel plan PN.

Like the first embodiment, the notification unit 13 performs, for example, the notification in step S304 using, for example, at least one of sound and visual indication. Specifically, the notification unit 13 operates the notification device 451 included in the HMI unit 45 to accordingly provide the notification to the occupant 80 through the notification device 451. This enables the notification to be provided to the occupant 80 in the form of, for example, at least one of sound and visual indication. After the operation in step S304 of FIG. 8, the notification control routine proceeds to step S305.

In step S305, the changing unit 14 of the manager 51 instructs the cloud computer 52 to change, i.e., update, the travel plan PN, so that the cloud computer 52 changes the travel plan PN. Specifically, the cloud computer 52 plans a new travel plan PN again, and the manager 51 causes the in-vehicle computer 32 and the HMI unit 45 to execute control in accordance with the newly planned travel plan PN.

For example, the planning of a new travel plan PN and execution of control based on the new travel plan PN can be carried out by the control routine illustrated in FIG. 4. Note that, when executing the control routine illustrated in FIG. 4 as the operation in step S305, the cloud computer 52 is configured to start the operation in step S102 while skipping the operation in step S101 because the information, such as the destination of the travel plan PN, inputted in step S101 has been already received therein.

In step S305, the cloud computer 52 may be configured to change, i.e., update, the travel plan PN to a new one immediately after the completion of the notification in step S304. In particular, the cloud computer 52 according to the first embodiment is configured to change, i.e., update, the travel plan PN to a new one after predetermined margin time has elapsed since the completion of the notification in step S304. In other words, the notification unit 13 is configured to complete the notification in step S304 with the predetermined margin time before the timing of changing, i.e., updating, the travel plan PN in step S305.

The predetermined margin time denotes a time period for avoiding a sense of discomfort that the occupant 80 may feel due to an abrupt change of the travel plan PN in step S305. The margin time may be, for example, several to a dozen seconds, does not need to be strictly fixed, and may have a certain range. The margin time according to the second embodiment may be set to be equal to or different from the margin time according to the first embodiment.

The following describes advantageous benefits achieved by the notification system 10 according to the second embodiment.

The determination unit 12 of the notification system 10 according to the second embodiment is configured to determine whether the predetermined change related to the travel plan PN, which denotes the automatic change of the travel plan PN during traveling of the vehicle 30, needs to be changed in step S302. This therefore enables the occupant 80 to recognize, by the notification in step S304, both (i) the automatic change of the travel plan PN and (ii) the one or more reasons of the automatic change of the travel plan PN prior to execution of the automatic change of the travel plan PN.

This configuration of the notification system 10 makes it possible to reduce, even if the cabin temperature control to follow the change of the travel plan PN is not intended by the occupant 80, an occupant's discomfort due to the occurrence of the change of the temperature in the cabin 30a of the vehicle 30.

The other advantageous benefits achieved by the second embodiment are substantially identical to those achieved by the first embodiment set forth above.

### Modification of Second Embodiment

The notification system 10 according to the second embodiment is configured to execute the notification control routine illustrated in FIG. 8 in place of the notification control routine illustrated in FIG. 6, but the notification system 10 according to a modification of the second embodiment is configured to execute both the notification control routine illustrated in FIG. 6 and the notification control routine illustrated in FIG. 8.

For example, in response to determination that the travel plan PN needs to be changed in step S302, the notification unit 13 according to this modification notifies, in step S304, the occupant 80 of (i) one or more reasons that the travel plan PN needs to be changed and (ii) information on the change of the travel plan PN prior to execution of the change of the travel plan PN. Changing the travel plan PN to a new one in step S305 may result in the target vehicle speed Vct or the target cabin temperature Trt being changed. In this case, in response to determination that the target vehicle speed Vct or the target cabin temperature Trt is scheduled to be changed in step S203, the notification unit 13 notifies, prior to execution of the change of the target vehicle speed Vct or the target cabin temperature Trt, the occupant 80 of (i) the one or more reasons that the change of the target vehicle speed Vct or the target cabin temperature Trt is to be executed and (ii) information on the change of the target vehicle speed Vct or the target cabin temperature Trt in step S204.

The vehicle 30 according to each of the first and second embodiments illustrated in FIG. 1, is an electric vehicle, which is an example. Specifically, the vehicle 30 is one of a hybrid vehicle, a plug-in hybrid vehicle, or a vehicle equipped with an internal combustion engine serving as an only driving power source.

The HMI unit 45 shown in FIG. 2 is provided on the instrument panel in the cabin 30a, which is merely an example.

For example, the notification system 10 according to each of the first and second embodiments of the present disclosure may include an external terminal connectable for data communication to the communication device 33 and the cloud communication device 53 via the wireless network NW. In this modification, one or more in-vehicle components do not constitute the HMI unit 45, and the external terminal may serve as the HMI unit 45. The external terminal may include a notification function as the notification device 451, which is a component of the HMI unit 45. The external terminal may be comprised of a portable computer, such as a tablet or a smartphone, operable by the occupant 80.

The HMI unit 45 illustrated in FIG. 2 includes both the input function and output function, which is merely an example. The HMI unit 45 may be implementable with only one of the input and output functions.

The electrical configuration of the vehicle 30 and cloud 50 according to the first embodiment is illustrated in FIG. 2, which is merely an example and therefore is not limited to that illustrated in FIG. 2.

The in-vehicle computer 32 shown in FIG. 2 need not be implemented by a single computer. The in-vehicle computer 32 may be implemented by multiple computers, which are for example provided for respective functions.

The evaluation function used in step S103 of FIG. 4 to determine the various parameters of the travel plan PN is defined to increase with higher evaluation, which is merely an example. The evaluation function may be defined to decrease with higher evaluation, in which case the parameters may be determined to minimize the value of the evaluation function.

The speed of the vehicle 30 and the temperature in the cabin 30a are automatically controlled in accordance with the travel plan PN during traveling of the vehicle 30 according to each of the first and second embodiments (see FIG. 3), which is merely an example.

For example, one of the speed of the vehicle 30 and the temperature in the cabin 30a may not be automatically controlled in accordance with the travel plan PN during traveling of the vehicle 30.

The notification unit 13 according to each of the first and second embodiments is configured to issue the notification to the occupant 80 using at least one of sound and visual indication, which is merely an example. Specifically, the notification unit 13 according to the present disclosure may be configured to issue the notification to the occupant 80 using other types of stimulus, such as vibration. For example, the HMI unit 45 may be configured to cause a seat 81 of the vehicle 30 to vibrate, and the notification unit 13 may be configured to instruct the HMI unit 45 to cause the seat 81 of the vehicle 30 to vibrate, thus performing the notification.

The information on the target-value change to be notified in step S204 of FIG. 6 is to increase or decrease the target vehicle speed Vct, which is merely an example. Specifically, the information on the target-value change to be notified in step S204 of FIG. 6 may be to change the target vehicle speed Vct.

The travel plan PN according to the first embodiment includes, as illustrated in FIG. 3, (i) the transition of the target speed Vct of the vehicle 30 from the start point Xst to the end point Xed of the scheduled travel route Lr, (ii) the transition of the target cabin temperature Trt from the start point Xst to the end point Xed of the scheduled travel route Lr, (iii) the transition of the target battery temperature Tbt from the start point Xst to the end point Xed of the scheduled travel route Lr, and (iv) the transition of the predicted SOC Spr of the high-voltage battery 34 from the start point Xst to the end point Xed of the scheduled travel route Lr,. The present disclosure is, however, not limited to the above. Specifically, the travel plan PN may not include a part of the above transitions (i) to (iv) or may include another information.

For example, assuming that the vehicle 30 includes a seat heater for heating the seat 81 of the occupant 80 illustrated in FIG. 1, the travel plan PN may include a transition of values of a target seat temperature, which denotes a target value of the temperature of the seat 81, from the start point Xst to the end point Xed of the scheduled travel route Lr.

Specifically, when starting the autonomous driving of the vehicle 30, the in-vehicle computer 32 according to this modification controls the seat heater such that the temperature of the seat 81 approaches the sequence of the values of the target seat temperature of the travel plan PN. The notification control routine illustrated in FIG. 6 can be carried out for the target seat temperature. The seat 81 may correspond to the predetermined portion of the vehicle 30 according to the present disclosure, and the temperature of the seat 81 corresponds to the temperature of the predetermined portion of the vehicle 30 according to the present disclosure. The seat 81 serving as the predetermined portion of the vehicle 30 is a portion in the vehicle 30 whose temperature variation is transferred to the occupant 80.

The autonomous driving of the vehicle 30 started in step S105 according to each of the first and second embodiments is, for example, configured to autonomously control the speed and the steering of the vehicle 30 in accordance with the travel plan PN, which is merely an example. Specifically, the autonomous driving of the vehicle 30 according to the present disclosure may be configured to autonomously control the speed of the vehicle 30 while the steering of the vehicle 30 is manually operated by the occupant 80.

Specifically, the notification control routine illustrated in each of FIGS. 6 and 8 may not be executed during autonomous driving of the vehicle 30, which autonomously controls both the speed and steering of the vehicle 30. Specifically, the notification control routine illustrated in each of FIGS. 6 and 8 may be executed except for the autonomous driving of the vehicle 30. For example, the notification control routine illustrated in each of FIGS. 6 and 8 may be executed during manual driving of the vehicle 30 by the occupant 80 as a driving entity.

The control routine illustrated in FIG. 4 is executed primarily by the cloud computer 52, i.e., by the cloud 50, which is merely an example. The control routine illustrated in FIG. 4 may be executed by, for example, an electronic control unit of the vehicle 30. The control routine illustrated in FIG. 4 may be executed by an external terminal when the external terminal is provided. The planning of a travel plan, including determination of a scheduled travel route Lr and selection of at least one of charging facilities CG used along the scheduled travel route Lr, may be implemented by any of the cloud 50, the vehicle 30, and the external terminal.

The determination unit 12, the notification unit 13, and the changing unit 14 illustrated in FIG. 7 are included in the cloud manager 51, which is merely an example. Any part or all of these components may be included in an electronic control unit of the vehicle 30, or, when the external terminal is provided, in the external terminal. Specifically, at least one of the components 12, 13, and 14 may be included in any of the cloud 50, the vehicle 30, and the external terminal. This makes it possible to improve design flexibility of the notification system 10 using a communication-network environment of the vehicle 30.

The operation in each step illustrated in the flowcharts of FIGS. 4, 6, and 8, which is implemented by one or more computer programs, may be implementable by hardware.

While the illustrative exemplary embodiments of the present disclosure have been described herein, the present disclosure is not limited to the exemplary embodiments and their configurations described herein. Specifically, the present disclosure includes various modifications and/or alternatives within the scope of the present disclosure. In addition to various combinations and forms, other combinations and forms including one or more/less elements thereof are also within the inventive principle and scope of the present disclosure.

One or more components in each of the exemplary embodiments are not necessarily essential components except for (i) one or more components that are described as one or more essential components or (ii) one or more components that are essential in principle.

Specific values disclosed in each of the exemplary embodiments, each of which represents the number of components, a physical quantity, and/or a range of a physical parameter, are not limited thereto except that (i) the specific values are obviously essential or (ii) the specific values are essential in principle.

In the exemplary embodiments, any mention of the materials, shapes, relative positions, etc., of components is not intended to be limiting, unless otherwise specified or where inherently limited by principle.

Sensors for acquiring external environmental information of the vehicle 30 (e.g., an outside air temperature) described in each of the embodiments may be omitted, and the external environmental information may instead be received from an external server of the vehicle 30 or from the cloud 50. The sensors may alternatively be omitted, and the vehicle 30 may obtain related information associated with the external environmental information from an external server or the cloud 50 and estimate the external environmental information based on the obtained related information.

The notification system 10 according to the present disclosure includes multiple control functional units, such as the determination unit 12, the notification unit 13, and the changing unit 14 shown in FIG. 7, which execute the operations in steps included in the flowcharts of FIGS. 4, 6, and 8. The control functional units and their methods described in the present disclosure may be implemented by a dedicated computer including a memory and a processor configured to execute one or more functions realized by one or more computer programs. The control functional units and their methods may also be implemented by a dedicated computer provided by one or more dedicated hardware logic circuits that configure the processor. The control functional units and their methods may further be implemented by a dedicated computer configured by a combination of (i) a memory and a processor programmed to execute one or more functions and (ii) a processor configured by one or more hardware logic circuits. The computer programs may be stored, as instructions to be executed by a computer, in a non-transitory tangible storage medium that is readable by the computer.

As used herein, “control circuitry” encompasses hardware implemented to perform the described functions, including one or more processors executing instructions, digital logic such as ASICs (“Application Specific Integrated Circuits”) and FPGAs (“Field Programmable Gate Arrays”), or combinations thereof. The phrase “configured to” is used to denote structure arranged to perform the recited function during operation and is not intended to invoke 35 U.S.C. § 112(f) absent express “means for” language.

The control circuitry may be implemented in or as part of any one or more of a manager, a cloud computer, an in-vehicle computer, and an HMI unit of the notification system 10. In certain embodiments, different portions of the control circuitry execute on different components and collectively implement the functions described herein.

The control circuitry may be configured to cause an appropriate portion of the notification system 10 to execute one or more functions as recited in each claim. Such configurations include implementations in which the control circuitry itself executes some or all of the claimed functions.

The following describes features of the present disclosure.

### [First Feature]

A notification system for a vehicle (30) according to the first feature includes a determination unit (12) configured to determine whether a predetermined change related to a predetermined travel plan of the vehicle needs to be executed. The vehicle is controlled to travel in accordance with the travel plan such that at least one of a speed of the vehicle or a temperature of a predetermined portion of the vehicle is automatically controlled to approach a target value. The predetermined change related to the travel plan is at least one of: a first automatic change of the target value by an absolute difference in accordance with the travel plan, the absolute difference being not less than a predetermined threshold, and a second automatic change of the travel plan during traveling of the vehicle. The notification system includes a notification unit (13) configured to provide, prior to execution of the predetermined change, a notification to an occupant of the vehicle in response to determination that the predetermined change related to the travel plan needs to be executed. The notification includes (i) at least one reason that the predetermined change related to the travel plan is to be executed and (ii) information on the predetermined change related to the travel plan.

### [Second Feature]

In the notification system according to the second feature, which depends from the first feature, the vehicle is an electric vehicle that includes a secondary battery (34) and travels based on power acquired from the secondary battery; and the travel plan is predetermined to enable the vehicle to travel while ensuring that a state of charge of the secondary battery remains not less than a predetermined allowable lower limit (Ls).

[Third feature]

In the notification system according to the third feature, which depends from the first or second feature, the notification unit is configured to provide the notification to the occupant using at least one of sound or visual indication.

[Fourth feature]

In the notification system according to the fourth feature, which depends from any one of the first to third features, the speed of the vehicle is automatically controlled to approach a target speed (Vct) as the target value. The predetermined threshold (D1tg) is a predetermined target-speed threshold defined as a threshold for the target speed. The absolute difference is an absolute target vehicle-speed difference. The predetermined change related to the travel plan is the first automatic change of the target speed by the absolute target vehicle-speed difference in accordance with the travel plan, the absolute target vehicle-speed difference being not less than the predetermined target-speed threshold.

### [Fifth Feature]

In the notification system according to the fifth feature, which depends from any one of the first to third features, the predetermined portion of the vehicle is a cabin (30a) of the vehicle. The temperature in the cabin is automatically controlled to approach a target cabin temperature (Trt) as the target value. The predetermined threshold (D1tg) is a predetermined target-temperature threshold defined as a threshold for the target cabin temperature. The absolute difference is an absolute target cabin-temperature difference. The predetermined change related to the travel plan is the first automatic change of the target cabin temperature by the absolute target cabin-temperature difference in accordance with the travel plan, the second absolute difference being not less than the predetermined target-temperature threshold.

[Sixth feature]

In the notification system according to the sixth feature, which depends from any one of the first to fourth features, the predetermined portion is a portion in the vehicle, a temperature variation of the portion being transferred to the occupant.

### [Seventh Feature]

In the notification system according to the seventh feature, which depends from any one of the first to third features, the predetermined change related to the travel plan is the second automatic change of the travel plan during traveling of the vehicle.

### [Eighth Feature]

The notification system according to the eighth feature, which depends from any one of the first to seventh features further includes a plan determination unit (51, 52) configured to determine the travel plan in accordance with information including (i) a current position of the vehicle, (ii) a destination, (iii) an ambient temperature around the vehicle, (iv) a traffic congestion around the vehicle, and (v) vehicle information including a speed of the vehicle and a present state of charge of the secondary battery. The travel plan includes:
(a) a scheduled travel route of the vehicle;
(b) at least one charging facility selected to be stopped during the scheduled travel route;
(c) a transition of a target speed of the vehicle during travelling of the vehicle, the target speed of the vehicle corresponding to the target value of the speed of the vehicle; and
(d) a transition of a target temperature of the predetermined portion of the vehicle, the target temperature of the predetermined portion of the vehicle corresponding to the target value of the temperature of the predetermined portion of the vehicle.

### [Ninth Feature]

The notification system according to the ninth feature, which depends from any one of the first to eighth features further includes a changing unit (14) configured to perform at least one of the first automatic change or the second automatic change as the predetermined change related to the travel plan.

### [Tenth Feature]

A program product for a vehicle (30) according to the tenth feature stores computer-program instructions. The computer-program instructions cause a processor to:
determine whether a predetermined change related to a predetermined travel plan (PN) of the vehicle needs to be executed,
   the vehicle being controlled to travel in accordance with the travel plan such that at least one of a speed of the vehicle or a temperature of a predetermined portion of the vehicle is automatically controlled to approach a target value (Vct, Trt),
   the predetermined change related to the travel plan being at least one of:
a first automatic change of the target value by an absolute difference (Dtg) in accordance with the travel plan, the absolute difference being not less than a predetermined threshold (D1tg); and
a second automatic change of the travel plan during traveling of the vehicle; and
   provide, prior to execution of the predetermined change, a notification to an occupant (80) of the vehicle in response to determination that the predetermined change related to the travel plan needs to be executed, the notification including (i) at least one reason that the predetermined change related to the travel plan is to be executed and (ii) information on the predetermined change related to the travel plan.

### [Eleventh Feature]

A notification method for a vehicle (30) according to the eleventh feature that is controlled to travel in accordance with a travel plan such that at least one of a speed of the vehicle or a temperature of a predetermined portion of the vehicle is automatically controlled to approach a target value (Vct, Trt) includes:
(a) determining whether a predetermined change related to a
predetermined travel plan (PN) of the vehicle needs to be executed,
the predetermined change related to the travel plan being at least one of:
   a first automatic change of the target value by an absolute difference (Dtg) in accordance with the travel plan, the absolute difference being not less than a predetermined threshold (D1tg); and
   a second automatic change of the travel plan during traveling of the vehicle; and
(b) providing, prior to execution of the predetermined change, a notification to an occupant (80) of the vehicle in response to determination that the predetermined change related to the travel plan needs to be executed, the notification including (i) at least one reason that the predetermined change related to the travel plan is to be executed and (ii) information on the predetermined change related to the travel plan.

1. A notification system for a vehicle, the system comprising:
control circuitry configured to cause the system to:
determine whether a predetermined change related to a predetermined travel plan of the vehicle needs to be executed,
the vehicle being controlled to travel in accordance with the travel plan such that at least one of a speed of the vehicle or a temperature of a predetermined portion of the vehicle is automatically controlled to approach a target value,
the predetermined change related to the travel plan being at least one of:
a first automatic change of the target value by an absolute difference in accordance with the travel plan, the absolute difference being not less than a predetermined threshold; and
a second automatic change of the travel plan during traveling of the vehicle; and
provide, prior to execution of the predetermined change, a notification to an occupant of the vehicle in response to determination that the predetermined change related to the travel plan needs to be executed, the notification including (i) at least one reason that the predetermined change related to the travel plan is to be executed and (ii) information on the predetermined change related to the travel plan.

2. The notification system according to claim 1, wherein:
the vehicle is an electric vehicle that includes a secondary battery and travels based on power acquired from the secondary battery; and
the travel plan is predetermined to enable the vehicle to travel while ensuring that a state of charge of the secondary battery remains not less than a predetermined allowable lower limit.

3. The notification system according to claim 1, wherein:
the control circuitry is configured to cause the system to provide the notification to the occupant using at least one of sound or visual indication.

4. The notification system according to claim 1, wherein:
the speed of the vehicle is automatically controlled to approach a target speed as the target value;
the predetermined threshold is a predetermined target-speed threshold defined as a threshold for the target speed;
the absolute difference is an absolute target vehicle-speed difference; and
the predetermined change related to the travel plan is the first automatic change of the target speed by the absolute target vehicle-speed difference in accordance with the travel plan, the absolute target vehicle-speed difference being not less than the predetermined target-speed threshold.

5. The notification system according to claim 1, wherein:
the predetermined portion of the vehicle is a cabin of the vehicle;
the temperature in the cabin is automatically controlled to approach a target cabin temperature as the target value;
the predetermined threshold is a predetermined target-temperature threshold defined as a threshold for the target cabin temperature;
the absolute difference is an absolute target cabin-temperature difference; and
the predetermined change related to the travel plan is the first automatic change of the target cabin temperature by the absolute target cabin-temperature difference in accordance with the travel plan, the second absolute difference being not less than the predetermined target-temperature threshold.

6. The notification system according to claim 1, wherein:
the predetermined portion is a portion in the vehicle, a temperature variation of the portion being transferred to the occupant.

7. The notification system according to claim 1, wherein:
the predetermined change related to the travel plan is the second automatic change of the travel plan during traveling of the vehicle.

8. The notification system according to claim 1, wherein:
the control circuitry is configured to cause the system to determine the travel plan in accordance with information including (i) a current position of the vehicle, (ii) a destination, (iii) an ambient temperature around the vehicle, (iv) a traffic congestion around the vehicle, and (v) vehicle information including a speed of the vehicle and a present state of charge of the secondary battery,
the travel plan including:
a scheduled travel route of the vehicle;
at least one charging facility selected to be stopped during the scheduled travel route;
a transition of a target speed of the vehicle during travelling of the vehicle, the target speed of the vehicle corresponding to the target value of the speed of the vehicle; and
a transition of a target temperature of the predetermined portion of the vehicle, the target temperature of the predetermined portion of the vehicle corresponding to the target value of the temperature of the predetermined portion of the vehicle.

9. The notification system according to claim 8, wherein:
the control circuitry is configured to cause the system to perform at least one of the first automatic change or the second automatic change as the predetermined change related to the travel plan.

10. A program product for a vehicle, comprising:
a non-transitory storage medium; and
computer-program instructions stored in the non-transitory storage medium,
the computer-program instructions causing a processor to:
determine whether a predetermined change related to a predetermined travel plan of the vehicle needs to be executed,
the vehicle being controlled to travel in accordance with the travel plan such that at least one of a speed of the vehicle or a temperature of a predetermined portion of the vehicle is automatically controlled to approach a target value,
the predetermined change related to the travel plan being at least one of:
a first automatic change of the target value by an absolute difference in accordance with the travel plan, the absolute difference being not less than a predetermined threshold; and
a second automatic change of the travel plan during traveling of the vehicle; and
provide, prior to execution of the predetermined change, a notification to an occupant of the vehicle in response to determination that the predetermined change related to the travel plan needs to be executed, the notification including (i) at least one reason that the predetermined change related to the travel plan is to be executed and (ii) information on the predetermined change related to the travel plan.

11. A notification method for a vehicle that is controlled to travel in accordance with a travel plan such that at least one of a speed of the vehicle or a temperature of a predetermined portion of the vehicle is automatically controlled to approach a target value, the notification method comprising:
determining whether a predetermined change related to a predetermined travel plan of the vehicle needs to be executed,
the predetermined change related to the travel plan being at least one of:
a first automatic change of the target value by an absolute difference in accordance with the travel plan, the absolute difference being not less than a predetermined threshold; and
a second automatic change of the travel plan during traveling of the vehicle; and
providing, prior to execution of the predetermined change, a notification to an occupant of the vehicle in response to determination that the predetermined change related to the travel plan needs to be executed, the notification including (i) at least one reason that the predetermined change related to the travel plan is to be executed and (ii) information on the predetermined change related to the travel plan.
